(19) United States
(12) Patent Application Publication
(10) Pub. No.: US 2002/0161599 A1
(43) Pub. Date: Oct. 31, 2002

(54) Electronic database of enzyme substrate and enzyme inhibitor structures

(76) Inventors: Carlos H. Faerman, Acton, MA (US); Patrick R. Connelly, Harvard, MA (US)

Correspondence Address: BANNER & WITCOFF, LTD., 28 STATE STREET, 28th FLOOR, BOSTON, MA, 02109, US

(21) Appl. No.: 09/945,941

(22) Filed: Sep. 4, 2001

Related U.S. Application Data
(60) Provisional application No. 60/230,551, filed on Sep. 5, 2000.

(51) Int. Cl. G06F 17/60

(52) U.S. Cl. 705/1

(57) ABSTRACT

An electronic database for identification of enzyme substrate and enzyme inhibitor structures that are structurally similar to a submitted chemical structure is provided. The enzyme substrate and enzyme inhibitor structures can be linked by numerous parameters, such as by Enzyme Classification Number. The database can be used to identify potential therapeutics for newly discovered enzymes or enzyme families.

This application claims priority to U.S. patent application Ser. No. 60/230,551 filed on Sep. 5, 2000.

### FIELD OF INVENTION

The present invention relates to enzyme substrates and enzyme inhibitors, particularly to a system that matches the two- and three-dimensional chemical structures of enzyme substrates and enzyme inhibitors to chemical structures submitted to the system.

### BACKGROUND

Several strategies exist for structure-based drug design. Two commonly used approaches are designing drugs for a specific enzyme or enzyme's active site and designing drugs based on the structures of the substrates and inhibitors of an enzyme. To use the method of designing drugs for a specific enzyme's active site, the three-dimensional structure of the active site must be known. However, determining the three-dimensional structure of an enzyme is not a simple task and in many cases is not possible. The structure of large enzymes, greater than 40-50 kDa in size, cannot be determined using multidimensional nuclear magnetic resonance because of the abundant dipolar interactions. Additionally, many enzymes are hydrophobic and/or membrane bound and are not easily crystallized for X-ray crystallography studies. Extraction of enzymes from membranes often results in aggregation of the enzymes due to entropically unfavorable interactions with aqueous solvents. Thus, the structure of many membrane bound enzymes and receptors remains unknown. Other methods have been devised, such as circular dichroism and the use of spin probes in combination with electron paramagnetic resonance, to deduce information about an enzyme's structure. However, in many instances these methods do not provide the resolution required for development of a faithful representation of an enzyme's active site.

With recent increases in the speed of computers many scientists have turned to computational chemistry to predict or to calculate the structure of unknown enzymes. Attractive and repulsive forces largely drive the native folding process and the resultant structure of an enzyme. Many computational algorithms do not take all of these forces into account because doing so results in a calculation that has no exact solution. For example, the goal in many computational methods is to find the lowest energy conformation for an enzyme by solving the Schrodinger equation. However, it is not possible to solve the Schrodinger equation exactly for any system larger than a hydrogen atom (1 proton only). Additionally, the structure of an enzyme determined from using theoretical computational methods, e.g. ab initio methods, is typically less reliable than the structure determined using X-ray crystallography and the like.

Since there are several obstacles to overcome when determining the structure of an enzyme for structure-based drug design, many scientists have focused on the synthesis of derivative compounds based on the structure of an enzyme's substrate. Pharmacologists and chemists are using these methods to identify potential drug candidates that target or inhibit enzymes that are involved in various diseases and conditions. One limitation of designing drugs using this method is determining the functional groups and types of compounds to synthesize. Generally, structural information about enzyme substrates is used to design a drug targeting one or more enzymes. For example, the substrate for enzyme A might be reduced nicotinamide adenine dinucleotide (NADH). Therefore, possible drugs for binding to enzyme A should be similar in structure to NADH but should have enough structural differences to promote inhibition of enzyme A. The determination of which functional groups that should be added or removed, to increase the inhibitory potency of the compound for example, and the site of attachment for these functional groups remains a trial and error process. In the NADH example discussed above, numerous possibilities exist for derivatization of the compound to form potential therapeutics. To encompass all potential therapeutics, every possible combination of derivatives containing functional groups, such as acetyl, methoxy, phenyl, etc., at any and all potential positions in the nicotinamide moiety and the adenosine moiety must be synthesized. In many instances, it is the interaction (i.e. electrostatic, covalent, van der Waals) between only one or a few functional groups that results in binding of the substrate or drug to the enzyme. Therefore, careful placement of one or more functional groups can provide a very effective therapeutic, whereas misplacement of a functional group may provide completely ineffective and/or toxic therapeutics.

To facilitate the design of therapeutics and identification of the therapeutic targets, it would be advantageous if compounds, such as enzyme substrates, enzyme inhibitors or structural portions thereof, having similar structure to a compound of interest, could be identified in a rapid manner to provide for synthesis of preferred drug candidates designed to target one or more enzymes. Because the enzyme or family of enzymes acted upon by a substrate or an inhibitor is usually known, every enzyme in an organism need not be screened to verify that it binds or does not bind to the synthesized compound. Therefore, it is possible to reduce the time required for screening the compounds by eliminating enzymes that are not likely to bind.

It is an object of the present invention to provide a database that links submitted chemical structures with structures of enzyme substrates and enzyme inhibitors. It is a particular object of at least certain preferred embodiments to provide a database of enzyme substrate and enzyme inhibitor structures that are linked in some manner, such as by Enzyme Classification Number, for example. Additional objects and aspects of the invention and of certain preferred embodiments of the invention will be apparent from the following disclosure and detailed description.

### SUMMARY

The present invention provides new links between enzyme substrates, enzyme inhibitors, and the chemical structure of a compound of interest using a system comprising an electronic database. Preferably, a system comprises a recordable electronic medium for receiving information input by a user, an electronic database, and at least one application program. The recordable medium may be any medium capable of receiving information, storing the information (temporarily or permanently) and providing access to the database. Preferably the recording medium is a memory unit, such as SDRAM and the like, a floppy disk, a hard disk drive, a compact disc, a writeable compact disc, a rewriteable compact disc, or other similar electronic devices and magnetic media that are designed to store and provide access to information. The electronic database is searchable using several different searching methodologies that are described in detail below. Preferably the electronic database comprises a list of linked enzyme substrates, or enzyme substrate structures, and enzyme inhibitors, or enzyme inhibitor structures. The application program acts as a means for processing information input by a user and is operative to output information, such as chemical structures for example, to and from the database. These chemical structures may include compounds that are submitted to the database for identifying structurally similar compounds contained in the database, or may include additional chemical structures of enzyme substrates and enzyme inhibitors that are being added to the database. Additionally, the application program acts to display one or more parameter tables containing any information deemed relevant by the database user or operator. This information may include information describing the enzyme, the Protein Data Bank Number of the enzyme if a structure exists for the enzyme, the CAS number, and any additional parameters that may be useful in structure-based drug design.

In accordance with a first aspect, an electronic database comprising enzyme substrate and enzyme inhibitor structures and a method for creating same is provided. The database comprises one or more files comprising enzyme substrate and enzyme inhibitor structures. The files may comprise information about each enzyme substrate and enzyme inhibitor structure. The enzyme substrate and enzyme inhibitors may be linked to enzymes that they bind to in any number of configurations. Preferably, the enzyme substrate and enzyme inhibitors are linked to the enzyme which they bind using the enzyme name or the Enzyme Classification (E.C.) Number. The E.C. Number is a number assigned to an enzyme or family of enzymes. Since this number is a constant, it provides a basis for linking substrates and inhibitors to the enzyme they bind. In an illustrative example, the database is created by submission of an enzyme name and its corresponding E.C. Number to a file that will eventually contain the enzyme substrate and enzyme inhibitor structures and the information about each enzyme substrate and enzyme inhibitor structure. Subsequently, the enzyme substrate and enzyme inhibitor structures that bind to the enzyme can be submitted to the file and linked to the enzyme name or to the E.C. Number. Therefore, when a search of the database is performed, in addition to returning an enzyme substrate that matches the submitted chemical structure, information such as the enzyme name and/or the E.C. Number may also be returned. The primary, secondary, tertiary or quaternary structure of the enzyme, if known, can also be returned. Additionally, any other substrates and inhibitors that are linked to the enzyme name or E.C. number may be returned. Thus, submission of one chemical structure may result in the return of numerous potential drug candidates that bind to an enzyme or family of enzymes.

In accordance with a second aspect, the enzyme substrate and enzyme inhibitor structures may be imported from several freely available sources. The enzyme substrate and enzyme inhibitor structures may also be created, and subsequently submitted to the database, using any commercial chemical drawing software such as, for example, ISIS/Draw™ available from MDL, Inc. (San Leandro, Calif.) or ChemDraw™ available from CambridgeSoft, Inc. (Cambridge, Mass.). The information about an enzyme contained in the file typically includes numerous parameters that are useful in aiding structure-based drug design. For example, this information may include, but is not limited to, the chemical name, the metabolic pathway, the enzyme that the substrate or inhibitor binds, the Enzyme Classification Number of the enzyme that the substrate or inhibitor binds to, and any other information deemed necessary by the database operator. The information may optionally include the Protein Data Bank Number of the enzyme that the substrate or inhibitor binds. Therefore, a user may retrieve the enzyme structure, from the Protein Data Bank (http://www.rcsb.org/pdb/) for purposes of docking the submitted chemical structure to the enzyme using any commercial molecular modeling software, such as Insight II™ available from Accelrys (San Diego, Calif.), SYBYL™ available from Tripos (St. Louis, Mo.), and the like.

In accordance with additional aspects, the database comprising enzyme substrate structures and enzyme inhibitor structures can be used to identify chemical structures that are similar to the enzyme substrate and inhibitor structures contained in the database. A two-dimensional or a three-dimensional chemical structure may be submitted to the database to obtain enzyme substrate and enzyme inhibitor structures that are similar to the submitted chemical structure. Chemical structures in the database that match the submitted structure in its entirety may be returned. This type of search is referred to herein as a similarity search and is described in detail below. To determine the extent to which a compound in the database must match the submitted chemical structure, one can specify the degree of similarity prior to submission of the chemical structure. For example, one could specify that only compounds having greater than 95% similarity to the submitted chemical structure be returned as matches. In this case, any resulting matches must necessarily be very close in structure to the submitted compound. If one desired to have a broader range of compounds matched to the submitted chemical structure, then compounds matching 40-60% of the submitted chemical structure would be specified, for example. Thus, in the latter example more compounds would be returned as matches, but some of the returned compounds may not be good candidates for therapeutics. One skilled in the art given the benefit of this disclosure will be able to design and perform similarity searches in accordance with the embodiments described herein.

In accordance with other aspects, the entire structure of a substrate or inhibitor in the database does not have to match the structure of the submitted chemical structure to be considered a match or hit. An aspect of using the database is that portions of enzyme substrate and enzyme inhibitor structures can be returned as matches. Searches obtained where a portion of the enzyme substrate or enzyme inhibitor structure matches are referred to herein as substructure searches and are described in detail below. The feature of substructure searching provides for matching of the submitted chemical structure to functional groups contained in the enzyme substrate and enzyme inhibitor structures. Therefore, key functional groups, and enzymes that bind compounds having these key functional groups, can be identified rapidly using this system. Since it is usually the functional groups that facilitate binding of a chemical compound to an enzyme, this feature of the system and database is especially advantageous.

In accordance with additional aspects, the database may also be used to identify potential chemical structures that may bind to a newly discovered enzyme. With current explosions in the amount of genomic information that is becoming available, it is expected that thousands of new enzymes will be identified. The searchable database disclosed herein can be used to identify potential therapeutics or inhibitors for these new enzymes. For example, one or more of the properties of a newly discovered enzyme can be submitted to the database. Preferably these properties include, but are not limited to, the structure of the newly discovered enzyme, the reaction that the newly discovered enzyme catalyzes, or the metabolic pathway that involves the newly discovered enzyme. The aforementioned properties can be elucidated using any methods known to those skilled in the art including, but not limited to spectroscopic techniques, such as nuclear magnetic resonance, light scattering or circular dichroism, crystallographic techniques, such as X-ray crystallography, computational techniques, such as molecular modeling, or other techniques commonly used to uncover protein structure and function. The database can be queried for enzymes that have similar properties as the newly discovered enzyme. Substrates and inhibitors that bind to any similar enzymes that are contained in the database may be returned as matches. The structures of the matching substrates and inhibitors may be used to design and synthesize therapeutics that target the newly discovered enzyme.

The ability to query this database based on substructures and/or molecular similarity can provide new connections between enzyme substrates and enzyme inhibitors within different branches of metabolic pathways. The two-dimensional structures in this database are used as the starting point to generate three-dimensional conformers for each structure, a powerful tool in drug discovery. Generation of three-dimensional structures may be performed using any method known to those skilled in the art including molecular modeling, computational chemistry, and the like. These and other objects and aspects of the technology disclosed here, and of preferred embodiments of such technology, will be understood from the following disclosure and detailed description of certain preferred embodiments.

### BRIEF DESCRIPTION OF FIGURES

The foregoing and other features and advantages of the present invention will be more fully understood from the following detailed description of certain preferred embodiments taken in conjunction with the accompanying drawings in which:

FIG. 1 shows a system for searching a database of enzyme substrate structures and enzyme inhibitor structures, in accordance with preferred embodiments;

FIG. 2 shows an overview of the process of querying the database and obtaining the resultant matches, in accordance with preferred embodiments;

FIG. 3 shows an example of creation of a similarity search list and a substructure search list from the results of querying the database, in accordance with preferred embodiments;

FIG. 4 shows a screenshot of a database having three windows, in accordance with preferred embodiments.

FIG. 5 shows a screenshot of the ECs window of the database that can list the compound's chemical name (Add), the enzyme classification number (ECNum), the entry name (ENT) and the metabolic pathway (Pathway), in accordance with preferred embodiments;

FIG. 6 shows a screenshot of the Biblios window of the database that can be used for entering bibliographic information about the compound, in accordance with preferred embodiments;

FIG. 7 shows a parameter table for molecular oxygen, in accordance with preferred embodiments;

FIG. 8 shows the result of importing the parameter table for molecular oxygen into the Structure window of the database, in accordance with preferred embodiments;

FIG. 9 shows one of many possible configurations for linking an enzyme substrate, an enzyme inhibitor, and an enzyme, in accordance with preferred embodiments;

FIG. 10 shows the results of a similarity search for a submitted chemical structure, in accordance with preferred embodiments;

FIG. 11 shows the results of a substructure search, in accordance with preferred embodiments;

FIG. 12 shows the linking of substrates, obtained from a substructure search, with the enzymes that each substrate binds, in accordance with preferred embodiments;

FIG. 13 shows a two-dimensional representation of L-methionine, in accordance with preferred embodiments;

FIG. 14 shows one match for a search of the database using L-methionine as the compound of interest, in accordance with preferred embodiments;

FIG. 15 shows one of many possible configurations for linking enzyme inhibitors and enzyme substrates with an enzyme, in accordance with preferred embodiments;

FIG. 16 shows the linking of an inhibitor to more than one enzyme, in accordance with preferred embodiments;

FIG. 17 shows one of many possible configurations for linking an enzyme with other members in the same enzyme family, in accordance with preferred embodiments; and

FIG. 18 shows one of many possible configurations for identifying potential therapeutics that target a newly discovered enzyme, in accordance with preferred embodiments.

### DETAILED DESCRIPTION OF CERTAIN PREFERRED EMBODIMENTS

It will be recognized from the above, that the novel database and system disclosed here can be formed in innumerable different configurations. The precise configuration of the database including the enzyme substrate and enzyme inhibitor structures, the nature of linking the enzyme substrate and enzyme inhibitor structures, the bibliographic information, and the like will depend in large part on the particular application and use for which it is intended. For convenience in this more detailed description of certain preferred embodiments, the database and systems comprising the database will generally be of a type suitable for use in identifying potential drug candidates that may bind to, and potentially inhibit, one or more enzymes or proteins. It will be within the ability of those skilled in the art, however, given the benefit of this disclosure, to select suitable configurations and designs for production of the database in accordance with the principles of the present invention, suitable for these and other types of applications.

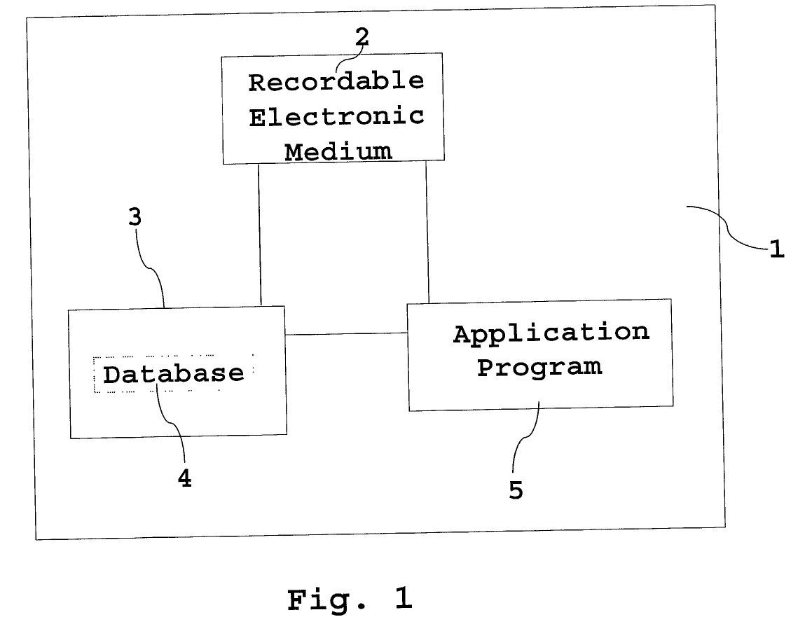

In accordance with certain preferred embodiments, a system for searching enzyme substrates and enzyme inhibitors to identify structures that are chemically similar to a chemical structure that is submitted for searching the database is provided. The system 1 comprises a recordable electronic medium 2, an electronic database 4 containing enzyme substrate and enzyme inhibitor structures, and an application program 5 for inputting and outputting chemical structures (see FIG. 1). The recordable electronic medium 2 may be any memory unit such as a DIMM, a SIMM, a computer processor, a computer system, or any other memory device that is capable of holding and accessing electronic information. The recordable electronic medium 2 may also be any device for storing data including but not limited to a compact disc, a writeable compact disc, a rewriteable compact disc, a hard disk drive, a floppy disk, a tape cartridge, or other magnetic media that is accessible, readable and/or writeable. The database 4 containing enzyme substrate and enzyme inhibitor structures may be any database, either commercial or written, but in certain embodiments is preferably a database that is created using ISIS/Base™, as discussed below. The application program 5 may be any means of inputting and outputting data, such as a chemical structure, but in certain embodiments is preferably a commercially available database or chemical drawing program such as those described herein.

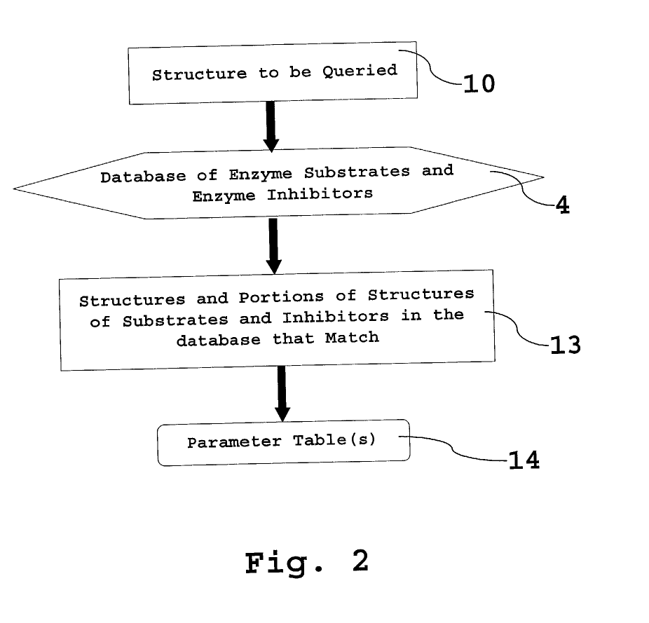

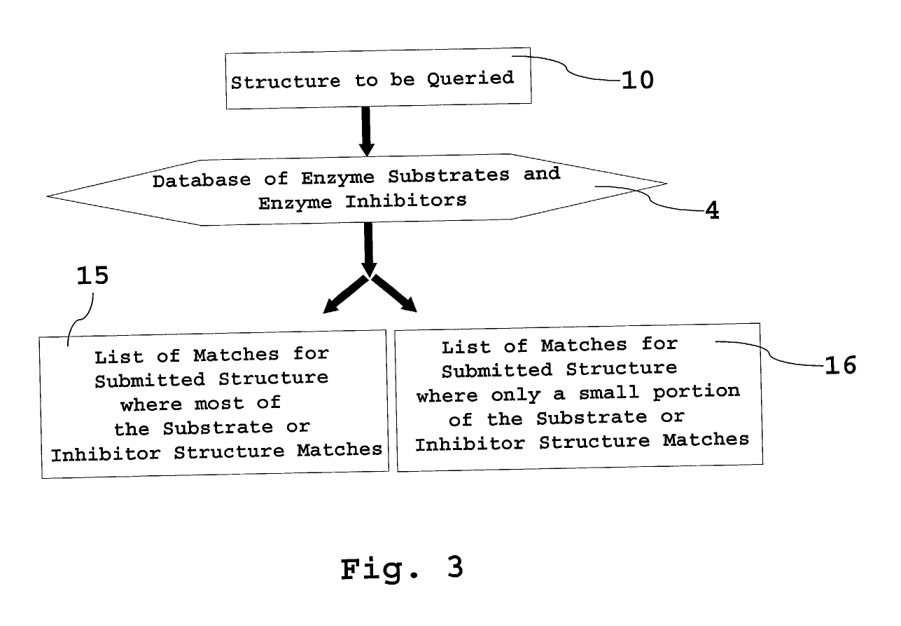

In accordance with certain preferred embodiments, FIG. 2 shows an overview of the process of using the system to identify enzyme substrate and enzyme inhibitor structures that are structurally similar to a submitted chemical structure. The submitted chemical structure 10 is referred to in some instances herein as the compound of interest. A chemical structure 10 can be submitted to the database. The database 4 can be queried for enzyme substrate and enzyme inhibitor structures that match the submitted chemical structure 10. The database 4 can compare and match the compound of interest to the structures or portions of the enzyme substrate and enzyme inhibitor structures contained within the database. The resulting matches or hits 13 may optionally be listed in a predetermined order. Hit or hits, as referred to herein, refers to any structure, or portion thereof, of an enzyme substrate or enzyme inhibitor contained in the database that matches in some manner (e.g. structurally) to the compound of interest. Optionally, the matches are returned in a predetermined order. This predetermined order could be any order but is preferably listed according to how similar the chemical structures in the database match the submitted chemical structure. For example, a chemical structure in the database that has exactly the same chemical structure as the compound of interest would be returned first. A chemical structure that differed slightly from the compound of interest, for example by only one functional group, would be lower in the list than a compound that exactly matches the submitted chemical structure. The type of search where similar compounds are matched in their entirety to the compound of interest is referred to, in some instances herein, as a similarity search. Structures containing only a portion of the submitted chemical structure can also be returned as hits. This type of search is referred to in some instances below as a substructure search. It is preferred, but not required, to have separate lists for hits returned from similarity and substructure searches. For example, a first list 15 may be generated for enzyme substrate structures and enzyme inhibitor structures that were matched using a similarity search (see FIG. 3). A second list 16 may be generated for enzyme substrate structures and enzyme inhibitor structures that were matched using a substructure search (see FIG. 3). For example, if the compound S-adenosyl-L-methionine was compared to a compound in the database, such as S-adenosyl-L-homocysteine (SAH), one would find that the compounds match almost completely, differing only by a single methyl group, and the match for SAH would be placed in the similarity search list 15. However, if only L-methionine was submitted to the database and compared with SAH, then only a portion of the SAH molecule would match, and the match for SAH would be placed in the substructure search list 16. Though described herein as separate and independent searches, the similarity search and the substructure search may be preformed simultaneously by the system and the resulting matches can be outputted to a single list or multiple lists.

In accordance with certain preferred embodiments, one or more parameter tables 14 of data may be returned with each match (see FIG. 2). The data in the parameter tables may be any information about the compound, including but not limited to the molecular structure, the names of similar enzyme substrate and enzyme inhibitor structures, the chemical name, a field identifying substrate and inhibitor structures that are known therapeutics, the identification of the enzyme that the compounds binds to in the form of a Protein Data Bank (PDB) Number, the Enzyme Classification (E.C.) Number or the like, bibliographic information, the type of molecule, and the metabolic pathway encompassing the compound. The E.C. Number assigned to an enzyme signifying the type of reaction that the enzymes catalyzes. The different families of enzymes and the reactions they catalyze are shown in table I.

TABLE I

| E.C. Number | Enzyme | Reaction |
|---|---|---|
| 1 | Oxidoreductases | Oxidation-reduction reactions |
| 2 | Transferases | Transfer of groups |
| 3 | Hydrolases | Hydrolysis reactions |
| 4 | Lyases | Addition reactions |
| 5 | Isomerases | Isomerization reactions |
| 6 | Ligases | Bond formation and ATP cleavage |

Within each E.C. Number family there exists numerous enzymes. For example, the enzyme hexokinase has an E.C. Number of E.C. 2.7. 1.1 indicating it transfers groups (family of E.C. 2), and more specifically, it transfers phosphate groups. Therefore, it is possible to classify enzyme substrates or inhibitors according to the enzyme they bind (i.e. assign one or more E.C. Numbers to a substrate). Returning the E.C. Number for a given substrate or inhibitor that matches the structure of the compound of interest provides the function and localization (i.e. where it is found in an organism) of potential targets for the compound of interest. Enzymes that occupy a given family can be screened as potential targets for the compound of interest.

In accordance with certain preferred embodiments, an electronic database of enzyme substrate and enzyme inhibitor structures is provided. The database comprises at least one file comprising enzyme substrate and enzyme inhibitor structures. Preferably, the database comprises two- and/or three-dimensional chemical structures of enzyme substrates and enzyme inhibitors. The file also comprises information about each enzyme substrate and enzyme inhibitor structure. This information includes but is not limited to the molecular structure, chemical name, entry name, CAS number, type of molecule, metabolic pathway, the E.C. Number or PDB Number of the enzyme that the enzyme substrate or enzyme inhibitor binds, any kinetic parameters such as K_{M}, Vₘₐₓ, K_{I}, K_{S}, or k_{cat}, the type of inhibition, and any relevant experimental conditions. One skilled in the art would recognize that the database may take numerous configurations. Preferably, the enzyme substrate and enzyme inhibitors may be linked to the enzymes that they bind. More preferably, the enzyme substrate and enzyme inhibitors are linked to the enzyme which they bind using the enzyme name or the Enzyme Classification (E.C.) Number. Since the E.C. number is a constant, it provides a basis for linking substrates and inhibitors to the enzyme they bind. In an illustrative example describing a single enzyme having a single inhibitor and a single substrate, the database would be organized by linking the substrate to the enzyme and by linking the inhibitor to the enzyme. Therefore, if a chemical structure is submitted to the database for searching and the substrate matches the submitted chemical structure, then the substrate would be returned as a match. However, since the substrate is linked to the inhibitor, through the enzyme that it binds, the structure of the inhibitor may also be returned as a match. This type of database organization provides for the retrieval of numerous compounds when a search of the database is performed for a submitted chemical structure. Thus, the probability of designing an effective therapeutic to target or inhibit an enzyme is increased.

In accordance with certain preferred embodiments, the database can be created by submission of an enzyme name and its corresponding E.C. Number to a file. Subsequently, the enzyme substrate and enzyme inhibitor structures that bind to the enzyme can be submitted to the file and linked to the enzyme name or to the E.C. Number. Therefore, when a search of the database is performed, in addition to returning an enzyme substrate that matches the submitted chemical structure, the enzyme name and/or the E.C. Number may be returned. Additionally, any other substrates and inhibitors that are linked to the enzyme name or E.C. number may also be returned. Thus, as discussed above, submission of one chemical structure may result in the return of several potential drug candidates that bind to an enzyme or family of enzymes.

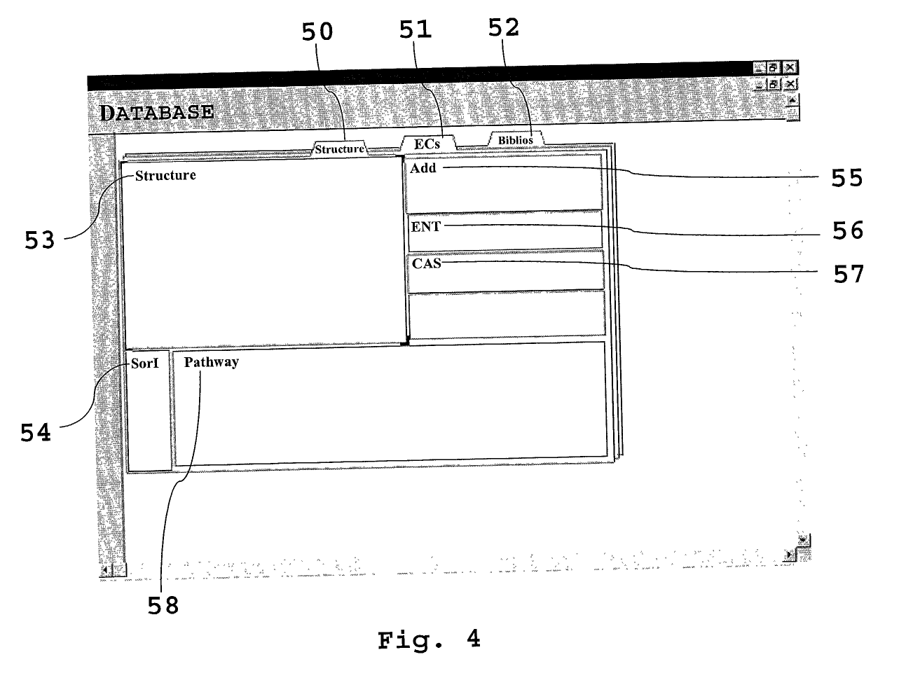

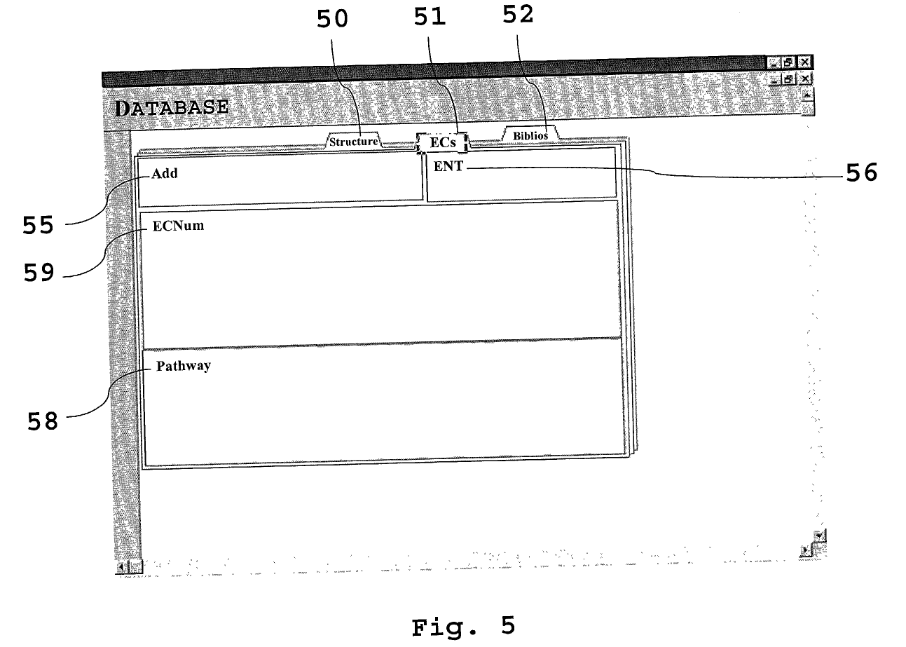

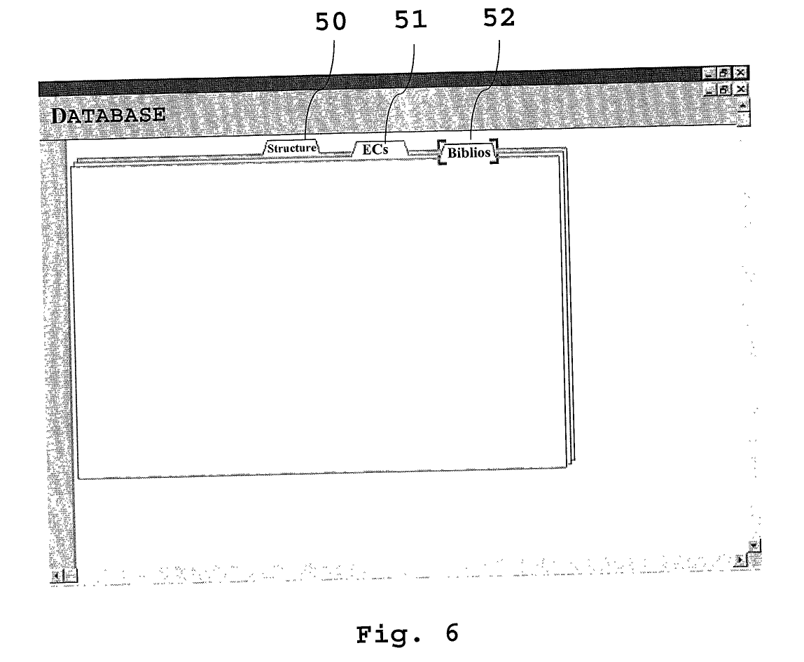

The database may be created using any commercially available database software including, but not limited to Oracle™ Access™, Paradox™ and the like, or the database may be created using computer languages, such as C++, Visual Basic, Java, or similar programming languages. In certain preferred embodiments, the database is created using ISIS/Base™ available from MDL, Inc. (San Leandro, Calif.). The database typically comprises one or more fields that are created to provide information for identifying the molecules in the database. These field tables can be arranged in three windows: Structure 50, ECs 51, and Biblios 52. In one of many possible configurations, the Structure window 50 comprises the following field parameters: Structure 53, SorI 54, Add 55, ENT 56, CAS 57, and Pathway 58 which represent molecular structure, type of molecule (substrate or inhibitor), chemical name, entry name, CAS number, and metabolic pathway respectively (See FIG. 4). The ECs window 51 comprises the following field parameters: Add 55, ENT 56, Pathway 58, and ECNum 59 where ECNum represents the Enzyme Classification Number (See FIG. 5). The Biblios window 52 is designed to add bibliographic information for each molecule in the database (see FIG. 6). Optional fields including, but not limited to the Protein Data Bank Number corresponding to the enzyme that the substrate or inhibitor binds, may be added to the Structure 51, ECs 52, or Biblios 53 window.

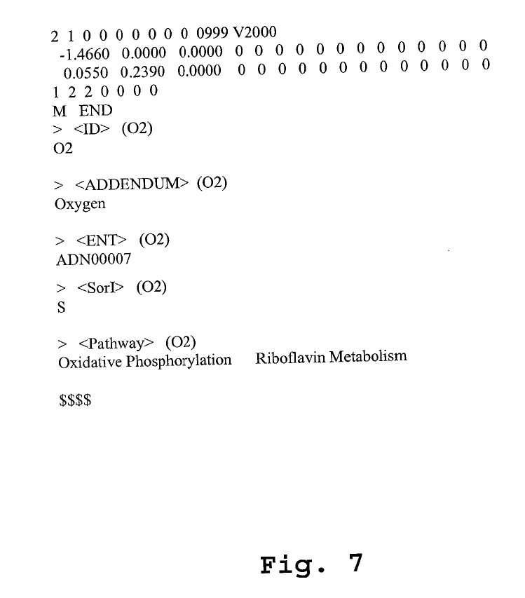

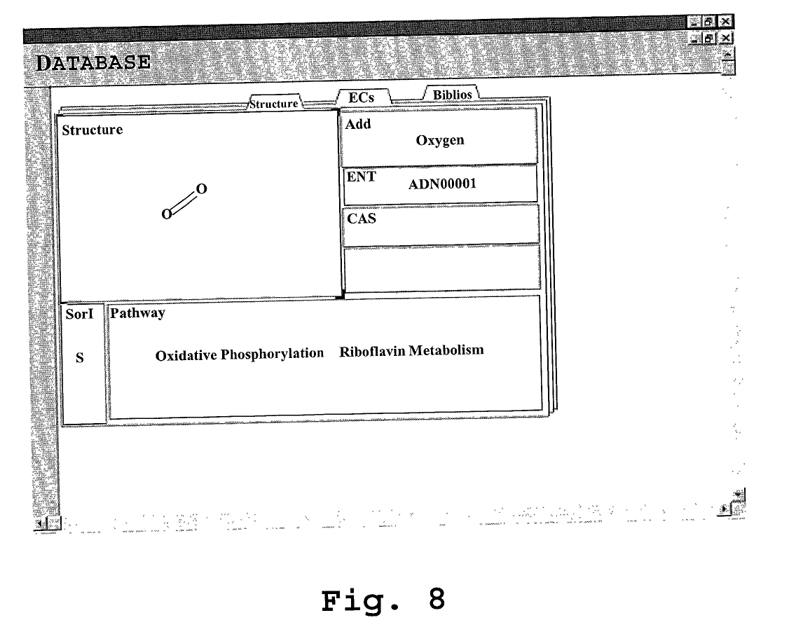

In accordance with certain preferred embodiments, after creation of the windows above, compounds, such as enzyme substrate and enzyme inhibitor structures, may be imported and registered. The structures may be stored in any file that is searchable. In certain embodiments, the molecules can be stored in a file called a structure data file (sdf). The sdf comprises the entire field parameters mentioned above and may optionally include other information about the enzyme. As an illustrative example, FIG. 7 shows the contents of an sdf for molecular oxygen. The contents of the file comprise the two-dimensional Cartesian coordinates of the molecule, the name of the molecule, the entry name, the type of molecule, and the metabolic pathways involving oxygen. Once the molecule is loaded into the database, the information in the sdf is extracted and displayed in the relevant field parameters (see FIG. 8). The molecule may be in the form of a two-dimensional chemical structure, as shown in FIG. 8, or optionally may be in the form of a three-dimensional chemical structure (not shown). One skilled in the art given the benefit of this disclosure will be able to select suitable files for importing into the database described here.

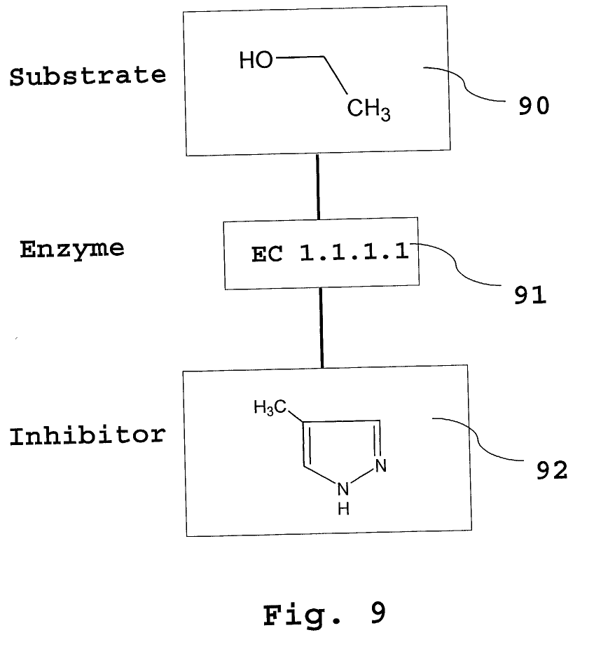

In accordance with certain preferred embodiments, the enzyme substrate and enzyme inhibitor structures that are imported into or contained within the database are linked by E.C. Numbers. For example, the enzyme alcohol dehydrogenase (ADH) (E.C. 1.1.1.1) can act on a variety of primary and secondary alcohols, such as ethanol, for example. Inhibitors of ADH include heavy metals and 4-methylpyrazole. One of many possible configurations for organizing a database entry for the substrate ethanol is shown in FIG. 9. The inhibitor 92 and the substrate 90 have been linked by the E.C. Number of the enzyme alcohol dehydrogenase 91. Therefore, if ethanol 90 is returned as a match for a submitted chemical structure, then the enzyme alcohol dehydrogenase and the inhibitor 4-methypyrazole may also be returned. Additionally, enzymes within the same family and their corresponding substrates and inhibitors can be linked together thus providing a wider choice of compounds as potential therapeutics.

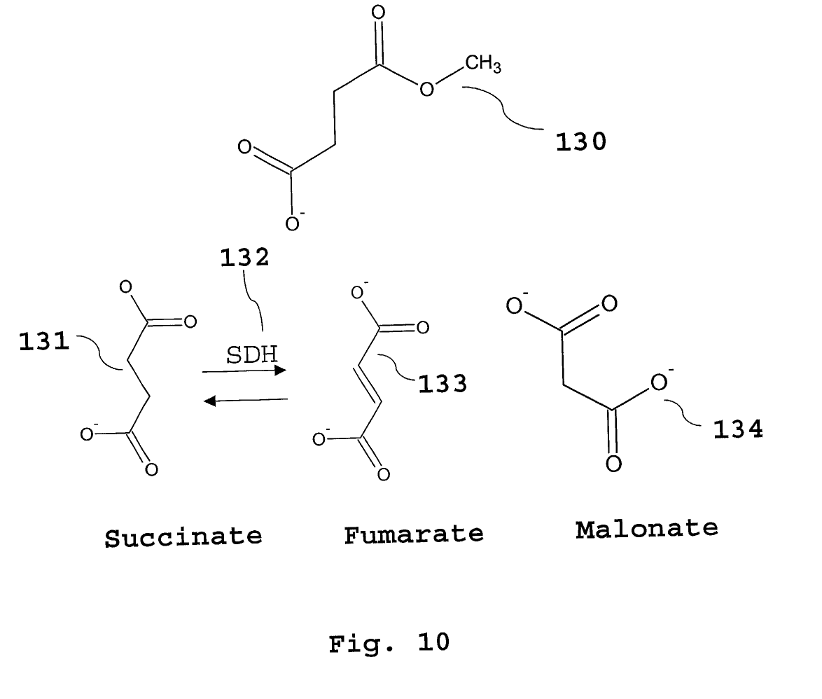

In accordance with certain preferred embodiments, an electronic database can be used to search for enzyme substrate and enzyme inhibitor structures that match the submitted chemical structure. Numerous uses of the database are possible, and discussed below and without limitation, are certain exemplary uses of the database. The database may be queried using any method known to those skilled in the art, but preferably the database is queried using a similarity search or a substructure search. One skilled in the art would recognize that the database may also be searched by enzyme name, Enzyme Classification Number, PDB Number, or any other data contained in a file or a structure data file comprising the enzyme substrate and enzyme inhibitor structures. An illustrative example of using the database for performing a similarity search is shown in FIG. 10. A chemical structure 130 can be submitted to the database of enzyme substrate and enzyme inhibitor structures. The database searches the structures of its list of enzyme substrates and enzyme inhibitors and returns any compounds that have a similar structure to the submitted compound 130. In this example, the database has returned two compounds, succinate 131 and fumarate 133, that are both very similar in structure to the submitted compound of interest 130. Additionally, the database has the capability of providing one or more enzymes that succinate and fumarate bind, which, in this example, is succinate dehydrogenase (SDH) 132, an enzyme of the tricarboxylic acid cycle. The E.C. Number, which is 1.3.99.1 in this example, may also be returned by the database. Based on the returned E.C. Number, compound 130 is most likely to bind to the family of enzymes known as oxidoreductases (see Table I, E.C. family 1). Therefore, this compound could be screened against different oxidoreductases to identify a potential target enzyme. In addition to providing the enzyme and the E.C. number, the database can also provide a list of inhibitors that bind to the enzyme. In this example, the database returns malonate 134, an inhibitor of SDH 132. Based on inhibitor information, including but not limited to inhibitory constants and modes of inhibition in the presence of malonate, it might be desirable to design additional compounds, based on the structure of malonate, for screening against selected oxidoreductases.

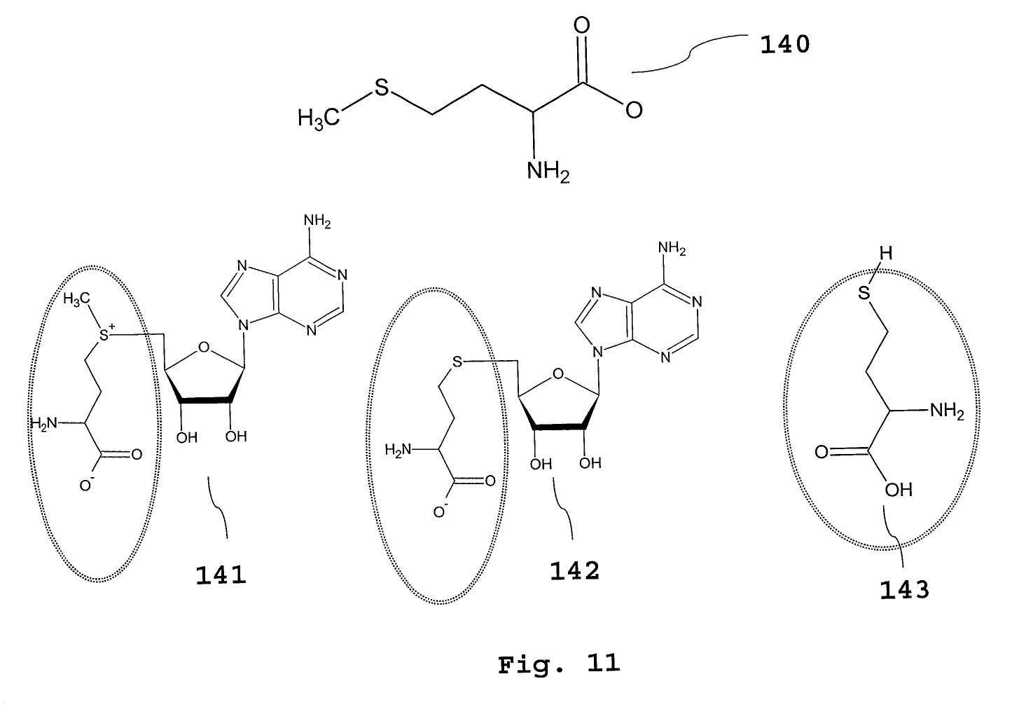

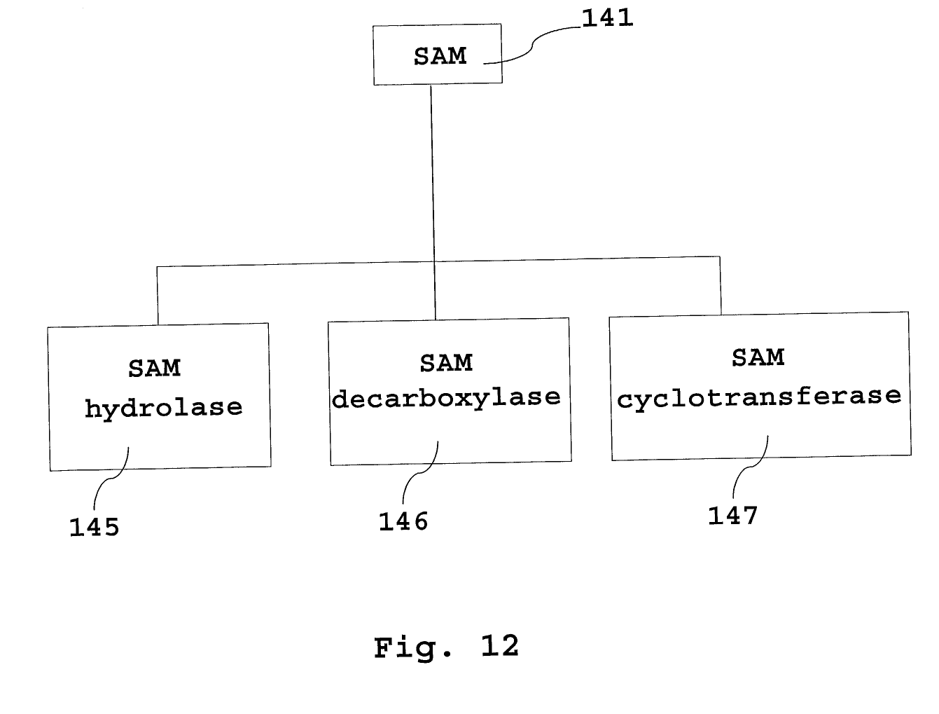

In accordance with certain preferred embodiments, an illustrative example of using the database for performing a substructure search is shown in FIG. 11. The amino acid L-methionine 140 is used as the compound of interest. After submission to the database, a portion of several compounds (circled portions in FIG. 11) matches the submitted compound 140. These compounds include S-adenosyl-L-methionine (SAM) 141, S-adenosyl-L-homocysteine (SAH) 142, and L-Homocysteine (HCys) 143. The database may also return the names of one or more enzymes, and the E.C. Number of the enzymes, that bind one or more of these compounds. For example, as shown in FIG. 12, the database can return several enzymes that bind SAM including hydrolases, such as S-adenosyl-L-methionine hydrolase 145 (E.C. 3.3.1.2), lyases, such as S-adenosyl-L-methionine decarboxylase 146 (E.C. 4.1.1.50), and transferases such as S-adenosyl-L-methionine cyclotransferase 147 (E.C. 2.5.1.4). Therefore, based on the returned E.C. Numbers, hydrolases (E.C. Number 3.x.x.x), lyases (E.C. Number 3.x.x.x) and/or transferases (E.C. Number 2.x.x.x) can be screened using compounds containing L-methionine as a functional group to probe for enzyme targets. In addition to returning the names of enzymes, the database can return inhibitors for these enzymes, such as 1-aminocyclopentanecarboxylic acid (not shown) in this example, thus providing for the synthesis of other potential therapeutics that target these enzymes. Optionally, one may wish to use the protein structure of the returned enzyme as a template to model the binding interaction of the enzyme and a drug candidate. One skilled in the art given the benefit of this disclosure will be able to use the database described here to identify potential chemical structures that bind to one or more enzymes or enzyme families.

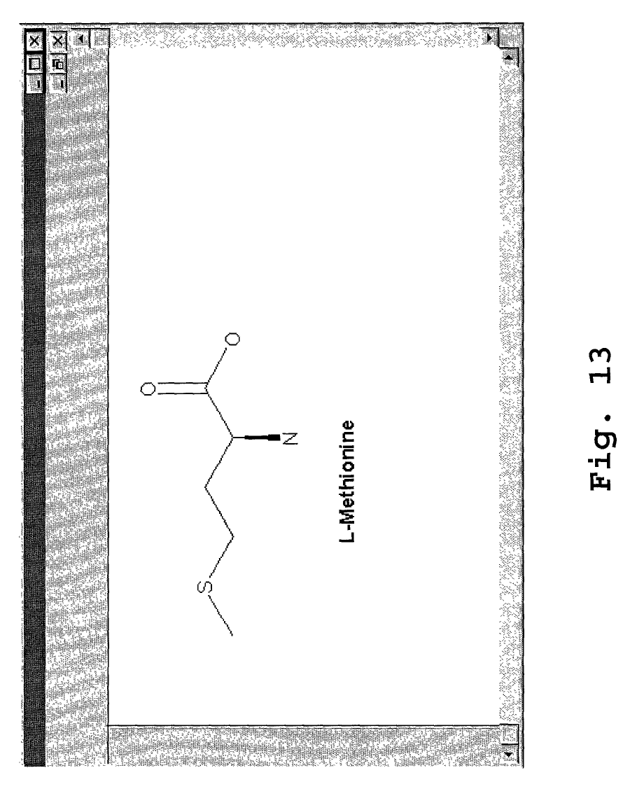

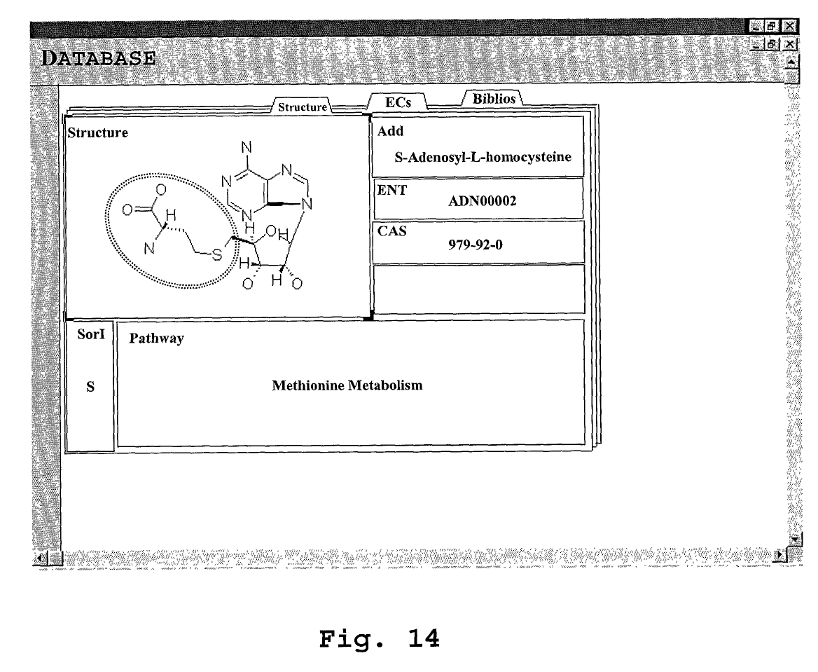

In accordance with certain preferred embodiments, a typical prerequisite to querying the database is that a two-dimensional structure of the compound of interest must exist. Several programs exist for creating two-dimensional structures including, for example, ChemDraw™, ACD Labs Chemsketch™, and ISIS/Draw™. FIG. 13 shows a two-dimensional representation of the chemical structure of L-methionine. The two-dimensional structure can be submitted to the database for finding potential matches with enzyme substrate and enzyme inhibitor structures in the database. Any molecule that contains all or a portion of the L-methionine structure may be returned as a match. In this example, over 16 hits were returned from the database. One match, S-adenosyl-L-homocysteine (SAH), is shown in FIG. 14. However, only the circled portion of SAH matches well with L-methionine. Therefore, this type of search would be considered a substructure search. In addition, other substrates and the enzymes that these substrates bind may be returned. The results from this search would be used for designing L-methionine based therapeutics that target one or more enzymes. One skilled in the art given the benefit of this disclosure will be able to perform substructure searches to identify chemical structures that bind to one or more enzymes or enzyme families.

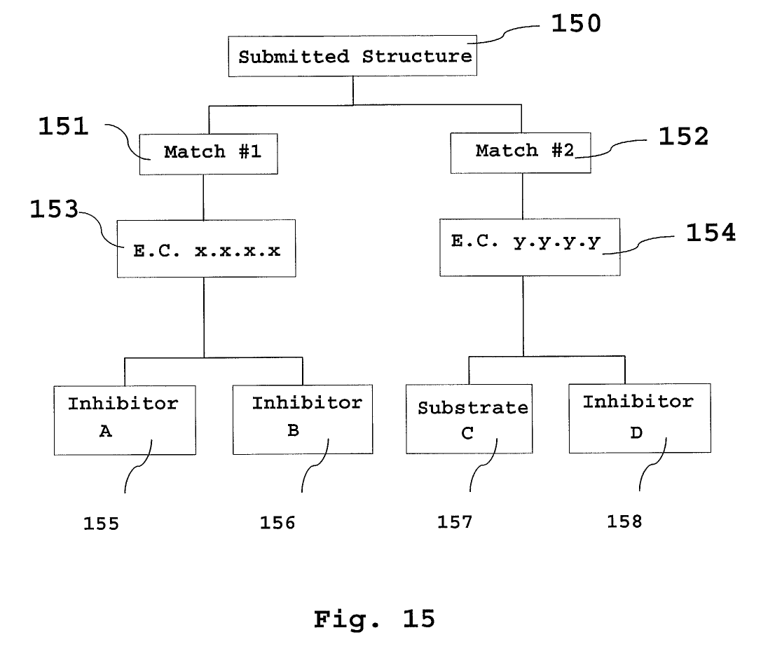

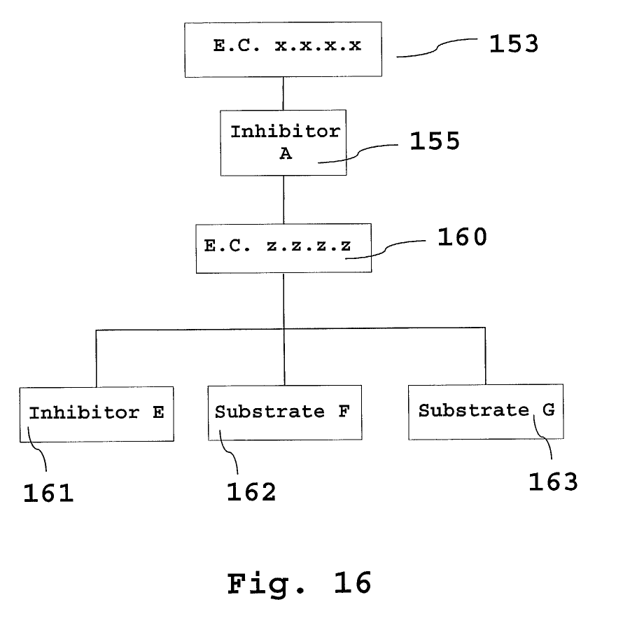

In accordance with certain preferred embodiments, a system comprising the database, as described above, can match submitted chemical structures with enzyme substrate and enzyme inhibitor structures that have a similar structure to the submitted chemical structure. However, the system may also be used for numerous other applications. For example, enzymes within the same family likely possess similar catalytic mechanisms and active site geometries. Therefore, one or more enzyme inhibitors or enzyme substrates that bind to a related enzyme may also bind to the target enzyme with high affinity. In many cases, an enzyme inhibitor or enzyme substrate for a first enzyme is not present in the same biological compartment, such as a mitochondria, Golgi, etc., as a second enzyme and thus no binding is possible. In accordance with preferred embodiments, a query of the database may also return multiple matches by using the linkage of the enzyme substrates and enzyme inhibitors to the enzyme. FIG. 15 shows a query of the database of enzyme substrate and enzyme inhibitor structures. A structure 150 can be submitted for searching the database and the results are a first compound that matches 151 and a second compound that matches 152. The first match 151 binds to enzyme E.C. x.x.x.x 153. Inhibitor A 155 and Inhibitor B 156 also bind to enzyme E.C. x.x.x.x 153 (see FIG. 15). The second match 152 binds to enzyme E.C. y.y.y.y, and this enzyme has a Substrate C 157 and an Inhibitor D 158. Therefore, six possible compounds (a first match 151, a second match 152, Inhibitor A 155, Inhibitor B 156, Substrate C 157, and Inhibitor D 158) have been obtained from a single search of the database. One skilled in the art would recognize that numerous other configurations and results are possible. For example, the six matches that were obtained may bind to enzymes other than E.C. x.x.x.x and E.C. y.y.y.y. Assuming that Inhibitor A 155 also binds to enzyme E.C. z.z.z.z 160 (see FIG. 16), then one might obtain other inhibitor and substrate structures from the database that may be used for designing therapeutics. As shown in FIG. 16, there are three compounds, Inhibitor E 161, Substrate F 162, and Substrate G 163 that bind to enzyme E.C. z.z.z.z 160. Therefore, this one search has returned a total of nine chemical structures and three enzyme families. The acquired information may then be used to design therapeutics to target one or more enzymes. One skilled in the art given the benefit of this disclosure will be able to select and design suitable therapeutics for inhibiting one or more enzymes or enzyme families.

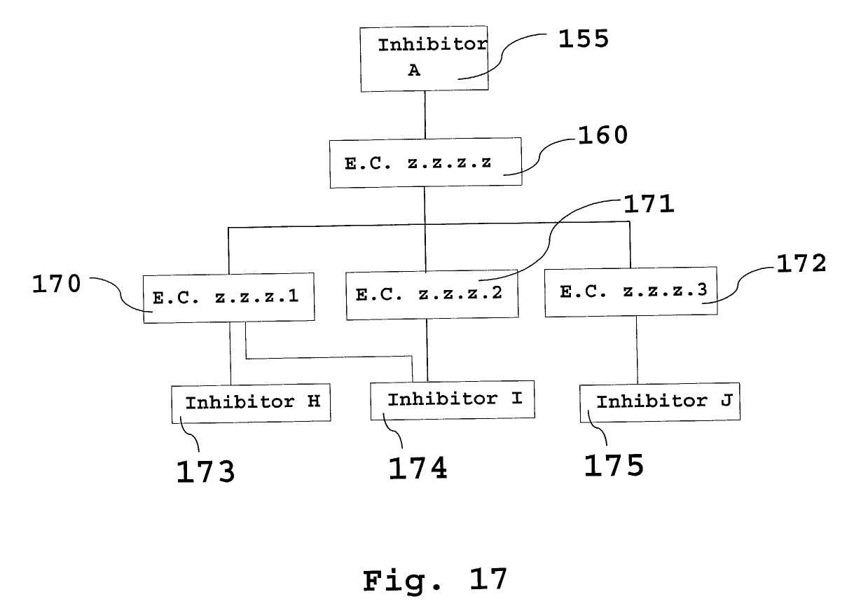

In accordance with certain preferred embodiments, the database may also be used to identify potential drug candidates by taking advantage of the relationship of enzymes within an E.C. family because it is highly probable that enzymes in the same family have similar catalytic mechanisms and similar active site geometries. Because it is advantageous to have a large number of potential therapeutics that have a high probability of targeting or inhibiting an enzyme, linking different enzymes within the same family can provide more chemical structures that may bind to an enzyme target. When a chemical structure is submitted to the database for searching, a match (match alpha) may be linked to an enzyme (enzyme alpha) as illustrated in detail above. Additionally, the enzyme (enzyme alpha) linked to the match may also be linked to other enzymes (enzyme beta) that are in the same family. Because enzyme beta may have its own substrates and inhibitors linked to it, and because enzyme beta is also linked to enzyme alpha, the inhibitors and substrates of enzyme beta may be returned with match alpha. An illustrative example to further clarify this feature is shown in FIG. 17. Inhibitor A 155 can be returned as a match for the submitted chemical structure. In this example, Inhibitor A 155 is linked to enzyme E.C. z.z.z.z 160. There may be numerous enzymes that comprise the enzyme family E.C. z.z.z.z. Three of these enzymes, E.C. z.z.z.1 170, E.C. z.z.z.2 171, and E.C. z.z.z.3 172, are shown in FIG. 17. Each of the three enzymes that are linked to E.C. z.z.z.z may have one or more linked enzyme inhibitors or enzyme substrates. Inhibitor H 173 and Inhibitor I 174 bind to E.C. z.z.z.1. Inhibitor I 174 binds to E.C. z.z.z.2, and Inhibitor J 175 binds to E.C. z.z.z.3. Therefore, a search of the database where Inhibitor A 155 is returned as a match may also return Inhibitor H 173, Inhibitor I 174, and Inhibitor J 175 as matches.

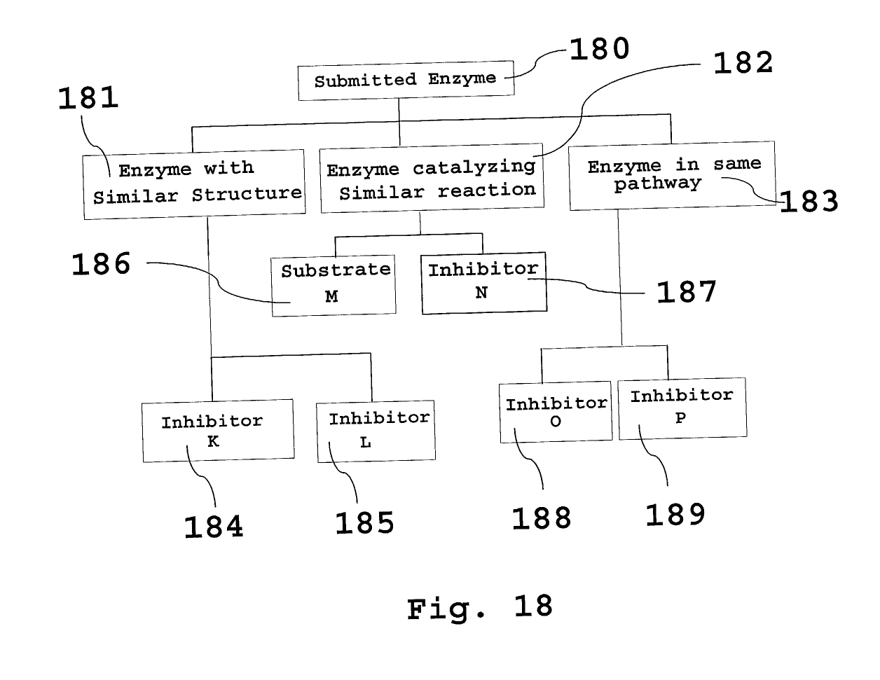

In accordance with other preferred embodiments, the electronic database disclosed here can be used to identify potential therapeutics or inhibitors for newly discovered enzymes. An illustrative example is described below and is shown in FIG. 18. The properties of a newly identified enzyme 180 can be determined using methods known to those skilled in the art. These properties include secondary and tertiary structure, elucidated using nuclear magnetic resonance, X-ray crystallography, molecular modeling and the like, the primary sequence, any reaction that the enzyme catalyzes, or other characteristics possessed by proteins. Once one or more of these properties is known, the enzyme can be submitted to the database for matching of enzymes that have similar structure, catalyze similar reactions, are localized in the same metabolic pathway, or have other shared enzymatic properties. For example, a newly discovered enzyme 180 can be submitted to the database (see FIG. 18). Searching of the database returns an enzyme having similar structure 181, an enzyme that catalyzes a similar reaction 182, and an enzyme that is localized in the same metabolic pathway 183. Inhibitors H 184 and K 185 bind to the enzyme 181 that has a similar structure to the submitted enzyme 180. Substrate M 186 and Inhibitor N 187 bind to the enzyme 182 that catalyzes a similar reaction to the submitted enzyme. 180 Inhibitors 0 188 and P 189 bind to the enzyme 183 localized in the same metabolic pathway as the submitted enzyme 180. Therefore, the system and database has rapidly identified potential compounds that will bind to the newly discovered and submitted enzyme 180 thus providing initial compounds for testing. In certain embodiments, the database may be used to identify known therapeutics and enzymes that bind to known therapeutics. For example, the structure of aspirin can be submitted to the database for identifying enzymes that bind to aspirin and structures that are similar to aspirin. Variants of aspirin may then be synthesized, and preferred variants that bind to one or more enzymes may be selected using any technique known to those skilled in the art. Preferably, the variants are selected using ACTT, which is described in detail in U.S. patent application Ser. No. 09/453,122 titled “Thermochemical Sensors and Uses Thereof,” the entire disclosure of which is hereby incorporated by reference for all purposes. The variants of known therapeutics may be more cost effective, may bind tighter, or may possess other advantages that would make the variants useful as therapeutics. One skilled in the art given the benefit of this disclosure will recognize that the structure of any known therapeutic may be submitted to the database to identify potential enzymatic targets and to identify variants of the known therapeutic.

Although the invention has been shown and described with respect to exemplary embodiments thereof, various other changes, omissions and additions in the form and detail thereof may be made therein without departing from the spirit and scope of the invention. It is intended in the claims below that the articles “a” and “an” include both the singular and plural forms of the nouns that the articles modify.

What is claimed is:

1. An electronic database comprising a plurality of enzyme substrate structures, a plurality of enzyme inhibitor structures, and at least one parameter table of data for identifying and linking the enzyme substrate structures and the enzyme inhibitor structures.

2. The electronic database in accordance with claim 1 wherein the data is selected from the group consisting of molecular structure, names of structurally similar substrates and inhibitors, chemical name of a structure, enzyme name, a field identifying the enzyme substrate structures and the enzyme inhibitor structures that are known therapeutics, identification of an enzyme that the enzyme substrate or enzyme inhibitor binds to in the form of a Protein Data Bank number or an Enzyme Classification Number, bibliographic information, type of molecule, and metabolic pathway.

3. The electronic database in accordance with claim 1 wherein the linking is by Enzyme Classification Number, enzyme name, enzymatic reaction or metabolic pathway.

4. The electronic database in accordance with claim 1 further comprising a window for submitting chemical structures to the electronic database.

5. The electronic database in accordance with claim 1 wherein the enzyme substrate structures and the enzyme inhibitor structures independently are two-dimensional chemical structures or three-dimensional chemical structures.

6. The electronic database in accordance with claim 1 wherein the one or more parameter tables are stored in a data file.

7. The electronic database in accordance with claim 1 further comprising a plurality of enzyme structures linked to the linked enzyme substrates and enzyme inhibitors.

8. The electronic database in accordance with claim 7 wherein the enzyme structure is selected from the group consisting of primary structure, secondary structure, tertiary structure, and quaternary structure.

9. A method for creating an electronic database of enzyme substrates and enzyme inhibitors comprising the steps of:
creating at least one file comprising,
a plurality of enzyme substrate structures,
a plurality of enzyme inhibitor structures, and
a plurality of data describing the enzyme substrate structures
and the enzyme inhibitor structures,
linking the plurality of enzyme substrate structures and the plurality of enzyme inhibitor structures.

10. The method of claim 9 wherein the data is selected from the group consisting of molecular structure, names of structurally similar substrates and inhibitors, chemical name of the structure, enzyme name, a field identifying the enzyme substrate and the enzyme inhibitor structures that are known therapeutics, identification of the enzyme that the compound binds to in the form of a Protein Data Bank number or an Enzyme Classification Number, bibliographic information, type of molecule, and metabolic pathway.

11. The method of claim 9 wherein the linking is by Enzyme Classification Number, enzyme name, enzymatic reaction or metabolic pathway.

12. The method of claim 9 wherein the enzyme substrate structures and the enzyme inhibitor structures independently are two-dimensional chemical structures or three-dimensional chemical structures.

13. The method of claim 9 further comprising linking a plurality of enzyme structures to the plurality of linked enzyme substrate structures and the plurality of enzyme inhibitor structures.

14. The method of claim 13 wherein the enzyme structure is selected from the group consisting of primary structure, secondary structure, tertiary structure, and quaternary structure.

15. A method of using an electronic database comprising a plurality of enzyme substrate and enzyme inhibitor structures, comprising the steps of:
submitting a chemical structure of a compound to the electronic database;
matching the chemical structure of the submitted compound to a plurality of enzyme substrate and enzyme inhibitor structures; and
outputting a list of said matched chemical structures.

16. The method of claim 15 further comprising the step of identifying one or more enzymes linked to the matching chemical structures.

17. The method of claim 15 further comprising the step of searching the database by submitting an enzyme name, a Enzyme Classification Number, or a Protein Data Bank Number.

18. The method of claim 15 wherein the submitted chemical structure is matched to the enzyme substrate structures and the enzyme inhibitor structures using a structural similarity search or a substructure search.

19. The method of claim 15 wherein the list comprises at least one parameter table of data for each enzyme substrate structure and each enzyme inhibitor structure that matches the submitted chemical structure.

20. The method of claim 19 wherein the data is selected from the group consisting of molecular structure, names of structurally similar substrates and inhibitors, chemical name of the compound, a field identifying said substrate and said inhibitor structures that are known therapeutics, identification of the enzyme that the substrates and inhibitors bind to in the form of a Protein Data Bank number or an Enzyme Classification Number, bibliographic information, type of molecule, and metabolic pathway.

21. The method of claim 15 wherein the chemical structure of the submitted compound is a two-dimensional chemical structure or a three-dimensional chemical structure.

22. The method of claim 15 wherein the enzyme substrate structures and the enzyme inhibitor structures independently are two-dimensional chemical structures or three-dimensional chemical structures.

23. A system for identification of chemical compounds comprising:
a recordable electronic medium for receiving information input by a user;
an electronic database, on the recordable electronic medium, comprising a list of linked enzyme substrates and enzyme inhibitors; and
at least one application program operative to process information in the recordable electronic medium and in the electronic database.

24. The system in accordance with claim 23 wherein the enzyme substrate structures and the enzyme inhibitor structures independently are two-dimensional chemical structures or three-dimensional chemical structures.

25. The system in accordance with of claim 23 wherein the recordable electronic medium is selected from the group consisting of a hard disk drive, a floppy disk, a compact disc, a writeable compact disc, a rewriteable compact disc, a tape cartridge, and other electronically recordable media.

26. The system of claim 23 wherein the at least one application program comprises a software program for drawing chemical structures.

27. A method of structure-based drug design comprising the steps of:
providing an electronic database of enzyme substrate and enzyme inhibitor structures;
outputting to a file enzyme substrate and enzyme inhibitor structures in the electronic database that match a chemical structure submitted to the database;
independently docking the outputted matched chemical structures with an enzyme;
identifying matches that dock successfully to the enzyme; and
designing therapeutics based on the identified matches.
